(19) United States
(12) Patent Application Publication
(10) Pub. No.: US 2025/0294349 A1
(43) Pub. Date: Sep. 18, 2025

(54) DEVICES, SYSTEMS, AND METHODS FOR CONNECTING TO AN EXERCISE DEVICE

(71) Applicant: iFIT Inc., Logan, UT (US)

(72) Inventor: Chris NASCIMENTO, Millville, UT (US)

(21) Appl. No.: 19/070,240

(22) Filed: Mar. 4, 2025

Related U.S. Application Data
(60) Provisional application No. 63/566,041, filed on Mar. 15, 2024.

(51) Int. Cl. H04W 12/06; A63B 24/00; H04W 12/63

(52) U.S. Cl. CPC H04W 12/06; A63B 24/0087; H04W 12/63

(57) ABSTRACT

An exercise device controller may receive a connection request to connect a third-party device to an exercise device. The exercise device controller may determine whether the third-party device is an authorized third-party device. When the third-party device is not an authorized third-party device, the exercise device controller may prevent operation of the exercise device. Additionally, or alternatively, the exercise device controller may operate the exercise device while connected to a third-party device, the third-party device including an identification that is authorized to adjust one or more exercise device settings of the exercise device. The exercise device controller may determine that the third-party device has been disconnected from the exercise device and, based on the third-party device being disconnected from the exercise device, may lock operation of the exercise device.

### CROSS REFERENCE

The present application for patent claims the benefit of U.S. Provisional Patent Application No. 63/566,041 by NASCIMENTO, entitled “DEVICES, SYSTEMS, AND METHODS FOR CONNECTING TO TREADMILL,” filed Mar. 15, 2024, which is assigned to the assignee hereof, and which is expressly incorporated by reference in its entirety herein.

### TECHNICAL FIELD

This disclosure relates generally to exercise devices and, more specifically, to devices, systems, and methods for connecting to an exercise device.

### BACKGROUND

Indoor exercise has increased in popularity and accessibility. Many people exercise indoors with the aid of an exercise device. Exercise devices may be designed to simulate outdoor exercise activities, such as a treadmill to simulate running, a stationary bicycle to simulate cycling, or a rower to simulate rowing. Additionally, or alternatively, exercise devices may be designed to exercise a certain muscle or muscle group, reduce the impact or force applied to the user, or aid in specific types of indoor exercises.

### BRIEF SUMMARY

In some aspects, the techniques described herein relate to a method for operating an exercise device. An exercise device controller receives a connection request to connect a third-party device to the exercise device. The exercise device controller determines whether the third-party device is authorized to operate the exercise device (e.g., whether the third-party device is an authorized third-party device). When the third-party device is not authorized to operate the exercise device (e.g., not an authorized third-party device), the exercise device controller prevents operation of the exercise device.

In some aspects, the techniques described herein relate to a method for operating an exercise device. An exercise device controller operates an exercise device while connected to a third-party device. The third-party device includes an identification that is authorized to adjust one or more exercise device settings of the exercise device. The exercise device controller determines that the third-party device has been disconnected from the exercise device. The exercise device controller, based on the third-party device being disconnected from the exercise device, locks operation of the exercise device.

This summary is provided to introduce a selection of concepts that are further described below in the detailed description. This summary is not intended to identify key or essential features of the claimed subject matter, nor is it intended to be used as an aid in limiting the scope of the claimed subject matter.

Additional features and advantages of embodiments of the disclosure will be set forth in the description which follows, and in part will be obvious from the description, or may be learned by the practice of such embodiments. The features and advantages of such embodiments may be realized and obtained by means of the instruments and combinations particularly pointed out in the appended claims. These and other features will become more fully apparent from the following description and appended claims or may be learned by the practice of such embodiments as set forth hereinafter.

### BRIEF DESCRIPTION OF DRAWINGS

To describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 is a representation of an exercise system, according to at least one embodiment of the present disclosure.

FIG. 2 is a representation of an exercise system including an exercise device and a third-party device, according to at least one embodiment of the present disclosure.

FIG. 3 is a representation of an exercise system including an exercise device and a third-party device, according to at least one embodiment of the present disclosure.

FIG. 4 is a representation of an exercise system including an exercise device and a third-party device, according to at least one embodiment of the present disclosure.

FIG. 5 is a representation of a treadmill lockout system, according to at least one embodiment of the present disclosure.

FIG. 6 is a flowchart of a method for operating and/or connecting to a treadmill, according to at least one embodiment of the present disclosure.

FIG. 7 is a flowchart of a method for operating and/or connecting to a treadmill, according to at least one embodiment of the present disclosure.

FIG. 8 is a flowchart of a method for operating and/or connecting to a treadmill, according to at least one embodiment of the present disclosure.

FIG. 9 is a flowchart of a method for operating and/or connecting to a treadmill, according to at least one embodiment of the present disclosure.

### DETAILED DESCRIPTION

This disclosure generally relates to devices, systems, and methods for an exercise device lockout system. The exercise device lockout system may include an exercise device, such as a treadmill, an elliptical device, a rower, a stationary bicycle, a cable extension device, any other exercise device, or combinations thereof. A third-party device may be connected to the exercise device. The exercise device may recognize the third-party device as an authorized third-party device. For example, the exercise device may recognize the third-party device by a device ID (such as an IP address), device type, a user ID that is logged into an application on the third-party device, multi-factor authentication, biometric information, any other authorization mechanism, or combinations thereof. When the exercise device identifies that the third-party device is authorized, the exercise device may be unlocked and/or receive instructions from the third-party device. In some embodiments, when the exercise device identifies that the third-party device is authorized, the exercise device may connect to the user device. The third-party device may send instructions to adjust one or more exercise device settings and/or operating parameters of the exercise device. When the exercise device identifies that the third-party device is not authorized (e.g., is unauthorized), the exercise device may be locked. For example, the exercise device may prevent adjustment of any exercise device settings and/or operating parameters. In some examples, the exercise device may stop operation of the exercise device. In this manner, and in accordance with at least one embodiment, the exercise device may only operate when an authorized device and/or an authorized user is connected to the exercise device.

In accordance with at least one embodiment of the present disclosure, the exercise device may include any type of exercise device. For example, the exercise device may include a treadmill, an elliptical device, a stationary bicycle, a rower, a cable extension device, any other exercise device, or combinations thereof. The exercise device may include one or more movable members. For example, a treadmill may include a motor connected to one or both of a front pulley and a rear pulley. A tread belt may be extended between the front pulley and the rear pulley, and rotation of the front pulley and/or the rear pulley may rotate the tread belt. The treadmill may include a tread deck, and an incline mechanism may change an incline of the tread deck. One or more exercise devices may include a flywheel and a movable device to rotate the flywheel, with the flywheel providing resistance to rotation. For example, an elliptical device may include pedals connected to the flywheel such that, when depressed, the pedals may cause the flywheel to rotate, while the flywheel provides resistance to depression of the pedals. In some examples, a stationary bicycle may include pedals and a drivetrain connected to the flywheel. In such examples, rotation of the pedals may rotate the flywheel. In some examples, a rower and/or a cable extension device may include a cable connected to the flywheel, and extension of the cable may cause the flywheel to rotate.

The exercise device may include one or more exercise device settings. The exercise device settings may include any setting of the exercise device. For example, the exercise device settings may include a tread belt speed, a flywheel resistance, an incline, a decline, a blower fan setting, any other exercise device setting, or combinations thereof. In some examples, the exercise device may include one or more operating parameters. The operating parameters may include one or more of the exercise device settings.

In accordance with at least one embodiment of the present disclosure, the third-party device may be a device configured to be in communication with the exercise device that is separate from the exercise device. The third-party device may include any type of third-party device. For example, the third-party device may include a user device, or a device owned and/or operated by a user. In some examples, the third-party device may include a mobile device, such as a mobile phone, a smartphone, a tablet, a phablet, a laptop computer, any other mobile device, or combinations thereof. In some examples, the third-party device may include a wearable device, such as a watch, a smartwatch, a ring, a heartrate monitor, a necklace, jewelry, an article of clothing, any other wearable device, and combinations thereof. In some examples, the third-party device may include any other device, including an internet of things (IoT) device, a near-field-communication (NFC) key, a sensor, a heartrate monitor, any other third-party device, or combinations thereof.

The exercise device may determine whether a third-party device and/or a user is authorized using any authorization mechanism. For example, the third-party device may receive a connection request from the third-party device. The connection request may include any type of connection request, such as a wireless connection request, a wireless connection request over a Wi-Fi network, a wireless connection request over a Bluetooth connection, any other wireless connection, or combinations thereof. The third-party device may determine an identifier for the third-party device based on the connection request. The third-party device may compare the identifier to a pre-approved list of authorized identifiers. If the identifier is on the pre-approved list of authorized identifiers, the exercise device may authorize the third-party device and/or the user. If the identifier is not on the pre-approved list of authorized identifiers, the exercise device may prevent operation of the exercise device. The pre-approved list of identifiers may be pre-determined based on a registration or other verification system. In some examples, authorization mechanism may include a connection to a shared network. For example, the exercise device may authorize the third-party device if the third-party device and the exercise device are connected to the same wireless network, wired network, any other network, or combinations thereof. In some examples, the exercise device may authorize the third-party device if the third-party device was previously authorized.

The identifier may be any type of identifier. For example, the identifier may be associated with the exercise device, such as an IP address that is unique to the third-party device. In some examples, the identifier may be associated with a user. For example, the identifier may be associated with a user login. The user may login to an application used to control the exercise device, and the exercise device may request the login information to receive the identifier. In some examples, the user login may be a user login associated with any application, operating system, server, network, computing device, any other system, or combinations thereof. In some examples, the user login may include a multi-factor authentication system. For example, the exercise device may receive the connection request. If the exercise device recognizes the third-party device, the exercise device may send a multi-factor authentication code to a communication handle associated with the ID in the connection request. If the user inserts the correct multi-factor authentication code, then the exercise device may authorize the third-party device.

In accordance with at least one embodiment of the present disclosure, the exercise device may prevent operation of the exercise device if the third-party device is not authorized. The exercise device may prevent operation of the exercise device in any manner. For example, the exercise device may lock out the exercise device if the third-party device is not authorized. Locking out and/or locking operation of the exercise device may include placing a physical lock or impediment to movement of a movable member of the exercise device. In some examples, locking out the exercise device may include disconnecting a power connection to an operating system of the exercise device. In some examples, locking out the exercise device may include disconnecting one or more input mechanisms from the exercise device. In some embodiments, preventing operation of the exercise device may include not connecting the third-party device to the exercise device. For example, the third-party device may provide instructions to operate the exercise device, and when the third-party device is not connected to the exercise device, the exercise device may not receive any instructions to operate the exercise device.

When the exercise device authorizes the third-party device, the exercise device may connect to the third-party device. For example, the exercise device may establish a two-way communication link between the exercise device and the third-party device. In some embodiments, when the exercise device authorizes the third-party device, the exercise device may be unlocked. For example, the exercise device may physically unlock a physical impediment to a movable member of the exercise device. In some examples, the exercise device may connect power to the exercise device and/or a movable member of the exercise device. In some examples, the exercise device may connect an input mechanism to the exercise device. In some examples, the exercise device may receive instructions from the third-party device to adjust one or more exercise device settings and/or operating parameters of the exercise device. When the exercise device receives the instructions from the third-party device, the exercise device may adjust the associated exercise device setting and/or operating parameter. In this manner, and in accordance with at least one embodiment, the exercise device may adjust its operation when instructed to by an authorized third-party device.

In accordance with at least one embodiment of the present disclosure, the exercise device may monitor the presence and/or connection status of the third-party device. For example, the exercise device may monitor to determine whether the third-party device is still connected to the exercise device. If the third-party device becomes disconnected, then the exercise device may be shut down and/or locked out. For example, if the third-party device becomes disconnected, the exercise device may stop operation of the exercise device and prevent further operation of the exercise device. In some examples, if the third-party device becomes disconnected, the exercise device may stop operation at a safe rate. For example, the third-party device may slow down a tread belt in accordance with industry safety standards (e.g., a safe reduction rate), reduce a resistance on a flywheel in accordance with industry safety standards (e.g., a safe reduction rate), retract cables, or otherwise reduce operation of the exercise device. In some examples, if the third-party device becomes disconnected, the exercise device may be placed in a standby mode. For example, a belt speed of the exercise device may be adjusted to a standby rate, the resistance of the flywheel may be adjusted to a standby resistance, the incline of the exercise device may be adjusted to a standby incline, any other adjustment, or combinations thereof. In some embodiments, if the third-party device is disconnected, the exercise device may wait for a reconnection period. The reconnection period may allow for continued operation of the exercise device during inadvertent disconnections, such as disconnections (e.g., losing a wireless connection) resulting from network connectivity issues, power supply issues, signal interference, any other connectivity issues, or combinations thereof.

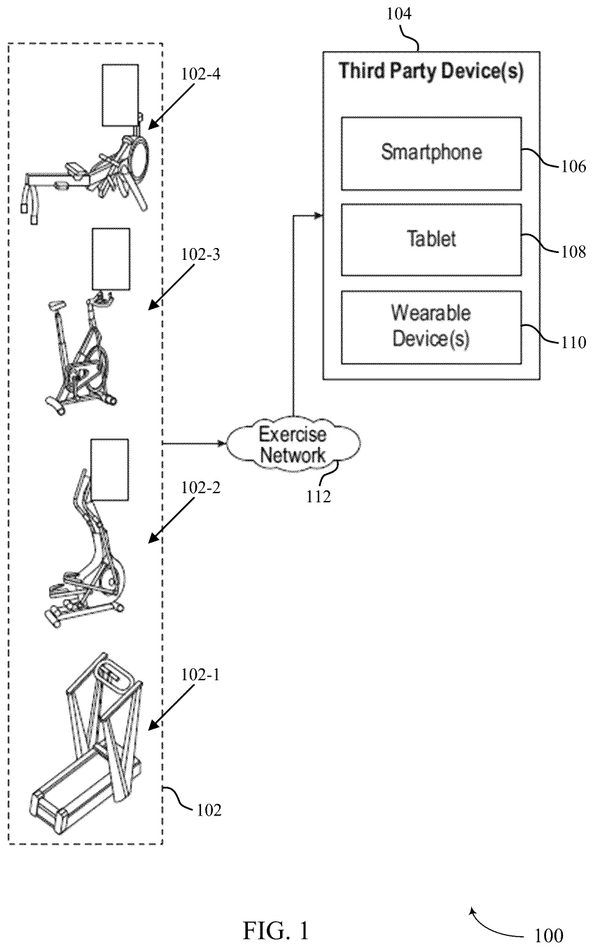

FIG. 1 is a representation of an exercise system 100, according to at least one embodiment of the present disclosure. As discussed herein, an exercise device (collectively exercise devices 102) may connect to an authorized third-party device 104. When the exercise device 102 connects to the authorized third-party device 104, the exercise device may be unlocked. This may facilitate operation of the exercise device by authorized users. In accordance with at least one embodiment, this may facilitate safe operation of the exercise device 102 by preventing access to the exercise device 102 by unauthorized users, such as minors.

As discussed herein, the exercise devices 102 may include any type of exercise device, such as a treadmill 102-1, an elliptical device 102-2, a stationary bicycle 102-3, a rower 102-4, a cable extension device, a mirror including a backlit display behind a mirrored surface, any other exercise device, or combinations thereof. While specific exercise devices 102 are illustrated and discussed herein, it should be understood that the techniques of the present disclosure may be applied to any exercise device that is capable of implementing an exercise program.

The exercise devices 102 may be configured to implement an exercise program. An exercise program may include a series of instructions for a user to perform actions of a workout. The instructions of the exercise program may include a pre-determined set of exercise program controls, which may change the operating parameters of the exercise device 102 at pre-determined times or pre-determined durations after the start of the workout. In some situations, an exercise program may include a video that is synchronized to the instructions and the pre-determined set of exercise program controls. The video may include depictions of a trainer, scenery, third-party media (e.g., a movie, a television show, a streaming video), any other video, or combinations thereof. The video may further include audio, such as commentary by a trainer, music, dialog, sound effects, any other audio, or combinations thereof. In some embodiments, the exercise device 102 may include a console supporting a display. The display may display the video of the exercise program.

In some embodiments, the exercise device 102 may not include a display. For example, the exercise device 102 may be a headless exercise device 102. Many people own computing devices, such as smartphones, tablets, laptop computers, computer monitors, and so forth. A user may utilize one of his or her devices (e.g., the third-party device 104) as the display for the exercise device 102. For example, the exercise program may be accessible by the third-party device 104, and the third-party device 104 may present the video and/or audio portions of the exercise program. As discussed herein, the third-party device 104 may include any type of third-party device 104, such as a smartphone 106, a tablet 108, wearable device 110, any other third-party device 104, and combinations thereof. Not including a display in the exercise device 102 may simplify the exercise device 102 and/or reduce the cost of the exercise device by facilitating use of the user's third-party device 104.

In accordance with at least one embodiment of the present disclosure, the third-party device 104 may be connected to the exercise device 102. For example, the third-party device 104 may be connected to the exercise device 102 over an exercise network 112. The exercise network 112 may be any type of network. For example, the exercise network 112 may be a local area network (LAN), a wide area network (WAN), a Wi-Fi network, a wired network, a cellular network, any other network, or combinations thereof. In some embodiments, the exercise device 102 may be connected to the third-party device 104 over a wireless connection, such as a Bluetooth, Zigbee, Z-wave, near-field communication (NFC), SON, any other wireless connection, or combinations thereof.

When the third-party device 104 is connected to the exercise device 102, the third-party device 104 may provide instructions to the exercise device 102. For example, the third-party device 104 may include an exercise program, and the third-party device 104 may provide the exercise program controls based on exercise program to the exercise device 102 over the exercise network 112. The exercise device 102 may receive the exercise program controls and adjust the operating parameters of the exercise device 102 based on the exercise program. In some embodiments, the third-party device 104 may transmit manual changes to the operating parameters of the exercise device 102 based on input by the user to the third-party device 104. For example, the third-party device 104 may include an application or a program. In the application, the user may select exercise programs, make manual changes to the operating parameters of the exercise device 102, review exercise parameters of the user (e.g., duration, distance, pace, speed, simulated weight, calories burned, heartrate, heartrate zone, incline, elevation gain, averages of the foregoing), view video of the exercise program, receive audio of the exercise program, perform any other activity related to the exercise program and/or operating the exercise device, or combinations thereof.

In accordance with at least one embodiment of the present disclosure, the exercise device 102 may have one or more authorized users. An authorized user may be a user that has permission to operate the exercise device 102. For example, an authorized user may be a user that is above a minimum age, has entered into a user agreement related to operating exercise device 102, has an account with the operator of the exercise device 102, has been trained in the operation of the exercise device 102, is licensed to operate the exercise device 102, is within certain physical criteria ranges (e.g., weight, height, arm length, weight length, strength, speed), any other authorized user, or combinations thereof. In some embodiments, the exercise device 102 may not be operated except by an authorized user. For example, the exercise device 102 may be locked out unless an authorized user is operating the exercise device 102. Limiting use of the exercise device 102 to authorized users may improve the safety of operating the exercise device 102.

In accordance with at least one embodiment of the present disclosure, the exercise device 102 may determine whether a user is authorized based on a connection to the third-party device 104. For example, when the third-party device 104 is connected to the exercise device 102, the exercise device 102 may determine whether the user is authorized based on information received from the third-party device 104. For example, the third-party device 104 may include identifying information. The identifying information may include a unique identifier for the third-party device 104, such as an IP address. When the third-party device 104 is connected to the exercise device 102, the exercise device 102 may determine whether the user is authorized based on the unique identifier. For example, the exercise device 102 may compare the unique identifier to a list of authorized identifiers. If the unique identifier is on the list of authorized identifiers, then the exercise device 102 may determine that the user is authorized. In this manner, a person that has access to the third-party device 104 may be authorized to operate the exercise device 102.

In some embodiments, the exercise device 102 may determine that a user is authorized in any other manner. For example, the third-party device 104 may include a user ID. The user ID may be an ID based on a login to an operating system, a login to an application, a login to a fitness system, any other user ID, or combinations thereof. When the exercise device 102 connects to the third-party device 104, the third-party device 104 may provide the user ID to the exercise device 102. In some embodiments, the exercise device 102 may request the user ID from the third-party device 104, and the third-party device 104 may provide the requested user ID to the exercise device 102. When the exercise device 102 determines that the user ID belongs to an authorized user, the exercise device 102 may authorize operation of the exercise device 102, or the exercise device 102 may not prevent operation of the exercise device 102.

In some embodiments, the exercise device 102 may determine an authorized user in any other manner. For example, the exercise device 102 may determine an authorized user based on a request for additional information. The additional information may include any type of additional information, such as a person identification number (PIN), a password, biometric information (e.g., fingerprint, face ID, EKG, any other biometric information, and combinations thereof), answering of security questions, multi-factor authentication (MFA), including MFA in the form of a code transmitted to a communication handle (e.g., phone number, email address, social media handle), any other additional information, or combinations thereof. The exercise device 102 may compare the received additional information, and if the received additional information matches additional information in a database or lookup table, then the exercise device 102 may determine that the user of the third-party device 104 is an authorized user (e.g., that the third-party device 104 is an authorized third-party device 104). While specific examples of authorization of the third-party device 104 and a user associated with the third-party device 104 have been provided herein, it should be understood that the techniques of the present disclosure may be applied to any authorization procedure or mechanism.

When the exercise device 102 determines that the third-party device 104 is an authorized third-party device 104 and/or that the user of the third-party device 104 is an authorized user, the exercise device 102 may become operable for the authorized user. For example, the exercise device 102 may be unlocked such that the authorized user may implement an exercise program or perform a workout on the exercise device 102.

When the exercise device 102 determines that the third-party device 104 is not authorized (e.g., is unauthorized), the exercise device 102 may prevent operation of the exercise device 102. Preventing operation of the exercise device 102 may include any mechanism to prevent operation of the exercise device 102. For example, preventing operation of the exercise device 102 may include preventing movement of a movable element of the exercise device 102. In some examples, preventing operation of the exercise device 102 may include disconnecting power or a power connection to one or more powered elements of the exercise device 102, such as one or more motors, brakes, incline mechanisms, and so forth. In some examples, preventing operation of the exercise device 102 may include locking out the exercise device 102, such as a mechanical lockout, an electrical lockout, an input lockout, any other lockout, and combinations thereof. In some examples, a mechanical lockout may include a mechanical impediment to movement of a movable element, thereby preventing movement of the movable element. In some examples, an input lockout may include a disconnection of one or more input mechanisms, including buttons or other input mechanisms. In some examples, an input lockout may include programming not to accept input from any source in the operating system of the exercise device 102. Preventing operation of the exercise device 102 may help to reduce inadvertent or unauthorized operation of the exercise device 102 by unauthorized users, thereby reducing the chance of injury by the unauthorized user.

In some embodiments, the exercise device 102 may identify multiple authorization categories. For example, the exercise device 102 may include a full authorization, in which all operating modes are available and operable by the user. In some embodiments, a reduced authorization may limit operation of the exercise device 102. For example, the reduced authorization may limit a belt speed of the treadmill, a resistance level of a flywheel, an incline level of the exercise device 102, any other limitation, and combinations thereof. The exercise device 102 may identify the reduced authorization based on the authorization techniques discussed herein.

In accordance with at least one embodiment of the present disclosure, the exercise device 102 may monitor the connection of the third-party device 104. When the exercise device 102 identifies that the third-party device 104 is disconnected from the exercise device 102, the exercise device 102 may prevent operation of the exercise device 102. For example, as discussed herein, the exercise device 102 may lockout the exercise device 102, implement programming to stop operation of the exercise device 102, or otherwise prevent operation of the exercise device 102. In this manner, the exercise device 102 may reduce or prevent unauthorized operation of the exercise device 102 based on the authorized user completing a workout and an unauthorized user utilizing the exercise device 102 after the authorized user.

In some embodiments, the exercise device 102 may gradually stop operation of the exercise device 102 when the third-party device 104 is disconnected. For example, the exercise device 102 may slow a belt speed of the tread belt, such as in accordance with operational safety standards. In some embodiments, the exercise device 102 may gradually reduce the resistance of a flywheel. In some embodiments, the exercise device 102 may gradually reduce the incline of the exercise device 102. In this manner, the exercise device 102 may stop gradually stop operation, thereby reducing or preventing injury to a user based on a sudden change in operating status of the exercise device.

In some embodiments, stopping operation of the exercise device 102 based on the third-party device 104 disconnecting from the exercise device 102 may include adjusting the operating state of the exercise device 102 to a minimum operating state. For example, a tread belt speed may be reduced to a slow walking pace (e.g., 1 mph, 2 mph), a flywheel resistance may be reduced, an incline may be readjusted to 0° incline, and so forth. In this manner, and in accordance with at least one embodiment of the present disclosure, the exercise device 102 may be returned to an operating state that may reduce or prevent injury.

In accordance with at least one embodiment of the present disclosure, the exercise device 102 may determine that the third-party device 104 has disconnected from the exercise device 102 in any manner. For example, the exercise device 102 may determine that the third-party device 104 is disconnected based on a loss of connection signal between the exercise device 102 and the third-party device 104. In some examples, the exercise device 102 may determine that the third-party device 104 is disconnected based on the third-party device 104 physically moving out of an operating area of the exercise device 102.

In some embodiments, the exercise device 102 may provide a reconnection period. For example, the third-party device 104 may become disconnected from the exercise device 102 based on connection issues, or the user temporarily leaving the room in which the exercise device 102 is located. The reconnection period may be a period of time in which the exercise device 102 may not stop operation while attempting to reestablish the connection between the exercise device 102 and the third-party device 104. This may help to reduce or prevent inadvertent stopping of the exercise device 102 due to inadvertent disconnection of the third-party device 104 from the exercise device 102.

In accordance with at least one embodiment of the present disclosure, the exercise system 100 may include multiple exercise devices 102. For example, the exercise system 100 may include multiple exercise devices 102 of the same type of device. In some examples, the exercise system 100 may include multiple exercise devices 102 of different types of exercise device. In some embodiments, each exercise device may authorize the user of the third-party device 104. In some embodiments, a single exercise device 102 of the exercise system 100 may authorize the third-party device 104 for all of the exercise devices 102 of the exercise system 100. This may facilitate the user performing exercises on different exercise devices 102, including moving between exercise devices 102 during the same workout.

In some embodiments, the exercise device 102 may disconnect from the third-party device 104 after a timeout period. The timeout period may be a period of inactivity and/or disconnection of the third-party device 104 from the exercise device 102. For example, if the third-party device 104 does not communicate with and/or cause a change in the third-party device 104 for a timeout period, then the exercise device 102 may disconnect the third-party device 104 and the exercise device 102.

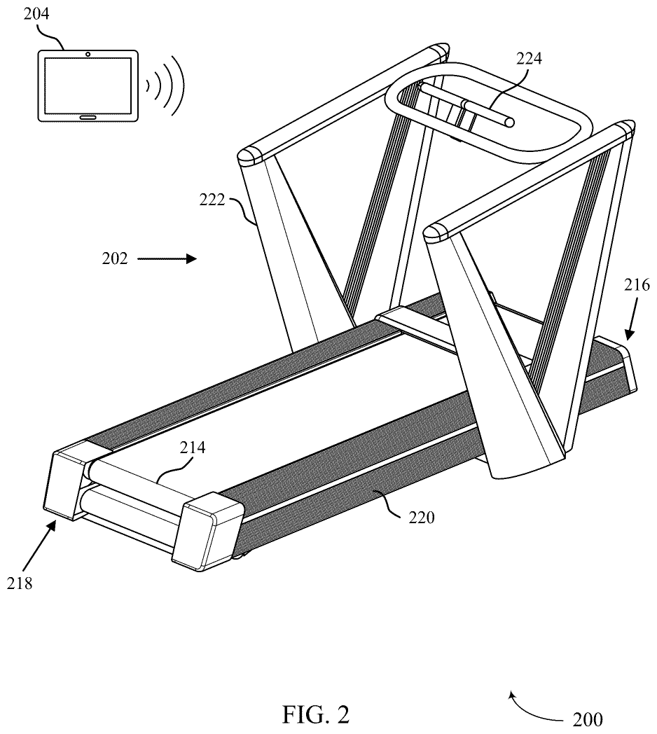

FIG. 2 is a representation of an exercise system 200 including an exercise device 202 and a third-party device 204, according to at least one embodiment of the present disclosure. While the exercise device 202 illustrated includes a treadmill, it should be understood that the exercise device 202 may include any exercise device 202, including the exercise devices 202 discussed herein. As may be seen, the exercise device 202 shown does not include a display. The exercise device 202 may include one or more movable elements, such as a tread belt 214, a front pulley at a front end 216 and a rear pulley at a rear end 218, with the tread belt 214 wrapped around the front pulley and the rear pulley. A belt motor may rotate one or both of the front pulley or the rear pulley, thereby causing the tread belt 214 to rotate in an endless loop. The tread belt 214 may be supported by a tread deck 220. Two uprights 222 may extend upwards at or near the front end 216, and a pair of handles 224 may extend between the two uprights 222. While the exercise device 202 is shown as including the two uprights 222 extending up from the tread deck 220, it should be understood that the techniques of the present disclosure may be applied to an exercise device 202 including the tread deck 220 and no console, display, two uprights 222, handles 224, or other elements extending upward from the tread deck 220.

During operation of the exercise device 202, the third-party device 204 may connect to the exercise device 202. For example, the exercise device 202 may send or receive a connection request from the third-party device 204, and the third-party device 204 may connect to the exercise device 202. As discussed herein, the third-party device 204 may connect in any manner, including with a wireless connection. The exercise device 202 may determine whether the third-party device 204 is an authorized third-party device 204. If the third-party device 204 is authorized, then the third-party device 204 may be connected to the exercise device 202.

When the third-party device 204 is connected to the exercise device 202, the third-party device 204 may transmit operating instructions to the exercise device 202. The operating instructions may include a change to one or more of the operating parameters of the exercise device 202. For example, the third-party device 204 may transmit instructions to adjust a belt speed of the tread belt 214, an incline of the tread deck 220, a fan speed of one or more fans incorporated into the two uprights 222, any other operating parameter, and combinations thereof.

As discussed herein, if the exercise device 202 does not authorize the third-party device 204, then the exercise device 202 may prevent operation of the exercise device 202. For example, the exercise device 202 may prevent the exercise device 202 from rotating the tread belt 214 and/or one or both of the front pulley or the rear pulley. In some examples, the exercise device 202 may prevent adjusting the incline of the tread deck 220. In this manner, and in accordance with at least one embodiment, the exercise device 202 may prevent unauthorized and/or inadvertent operation of the exercise device 202, thereby reducing or prevent damage to the exercise device 202 or injury to the unauthorized or inadvertent user.

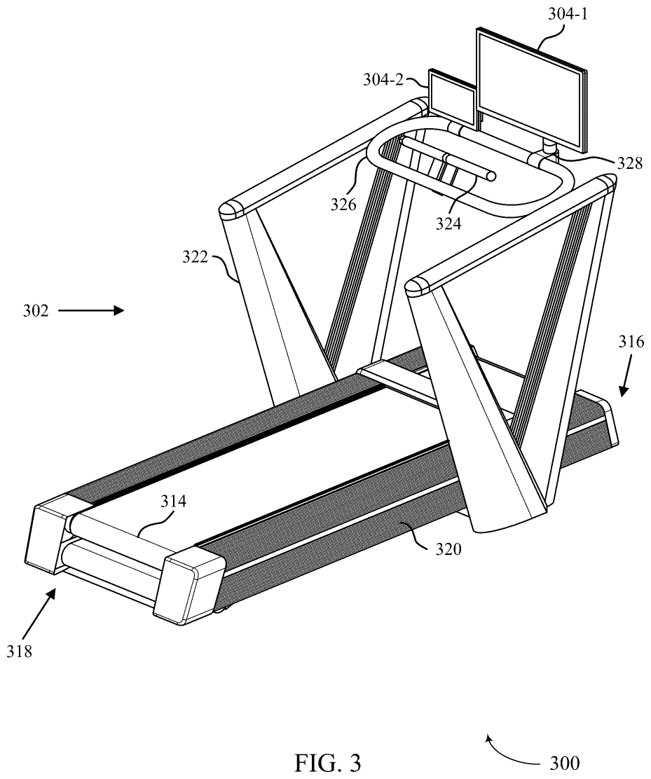

FIG. 3 is a representation of an exercise system 300 including an exercise device 302 and a third-party device 304, according to at least one embodiment of the present disclosure. While the exercise device 302 illustrated includes a treadmill, it should be understood that the exercise device 302 may include any exercise device 302, including the exercise devices 302 discussed herein. The exercise device 302 may include one or more movable elements, such as a tread belt 314, a front pulley at a front end 316 and a rear pulley at a rear end 318, with the tread belt 314 wrapped around the front pulley and the rear pulley. A belt motor may rotate one or both of the front pulley or the rear pulley, thereby causing the tread belt 314 to rotate in an endless loop. The tread belt 314 may be supported by a tread deck 320. Two uprights 322 may extend upwards at or near the front end 316, and a pair of handles 324 may extend between the two uprights 322.

In the embodiment shown, a console 326 may include a device support 328. The device support 328 may support a third-party device (collectively 304). The third-party device 304 may be secured to the console 326 by connecting to the device support 328, such as through a bracket, a clamp, a case for the third-party device 304, any other connection mechanism, and combinations thereof. In this manner, a user may secure his or her third-party device 304 to the exercise device 302, thereby placing the third-party device 304 in a location easily viewed while performing the exercise activity.

In accordance with at least one embodiment of the present disclosure, the exercise device 302 may connect to and/or authorize multiple third-party devices 304. For example, the exercise device 302 may connect to a first third-party device 304-1 and a second third-party device 304-2. The first third-party device 304-1 and the second third-party device 304-2 may display different content, include different controls, identify different elements of an exercise program, and so forth. In this manner, the exercise system 300 may be customizable to the user's preferences. In some embodiments, the first third-party device 304-1 and the second third-party device 304-2 may be the same type of device. In some embodiments, the first third-party device 304-1 and the second third-party device 304-2 may be different devices. For example, the first third-party device 304-1 may be a tablet and the second third-party device 304-2 may be a smartphone. In some examples, one of the third-party devices 304 may be a wearable device. In some examples, the third-party devices 304 may include any combinations of devices.

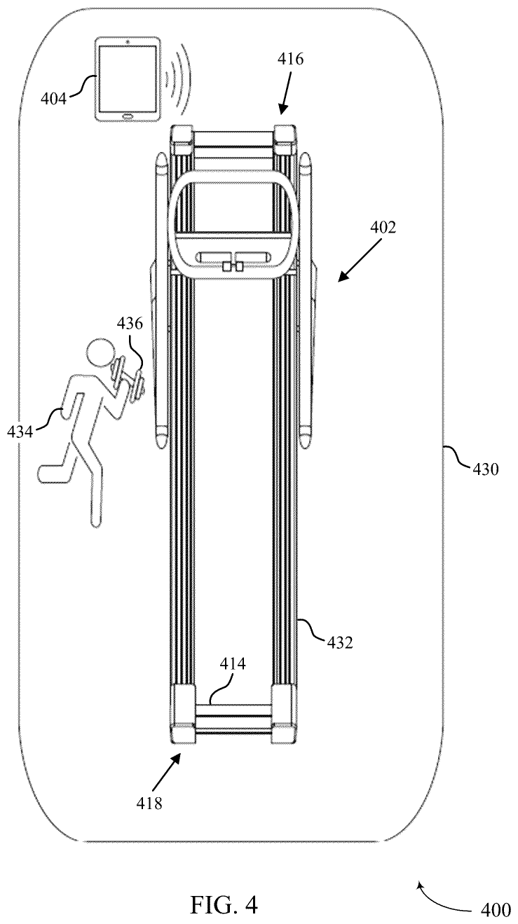

FIG. 4 is a representation of an exercise system 400 including an exercise device 402 and a third-party device 404, according to at least one embodiment of the present disclosure. While the exercise device 402 illustrated includes a treadmill, it should be understood that the exercise device 402 may include any exercise device 402, including the exercise devices 402 discussed herein. The exercise device 402 may include one or more movable elements, such as a tread belt 414, a front pulley at a front end 416 and a rear pulley at a rear end 418, with the tread belt 414 wrapped around the front pulley and the rear pulley. A belt motor may rotate one or both of the front pulley or the rear pulley, thereby causing the tread belt 414 to rotate in an endless loop. As discussed herein, the exercise device 402 may not include a display.

As discussed herein, the exercise device 402 may authorize the third-party device 404. In accordance with at least one embodiment of the present disclosure, the exercise device 402 may authorize the third-party device 404 when the third-party device is located within a threshold distance 430 of an outer perimeter 432 of the exercise device 402, and the exercise device 402 may lock the exercise device 402 when the third-party device 404 is outside of the threshold distance 430. The outer perimeter 432 may be the outer surface of the exercise device 402. In some embodiments, the threshold distance 430 may be identified based on a distance from a center of the exercise device 402. When the third-party device 404 moves away from the exercise device 402 farther than the threshold distance 430, the exercise device 402 may disconnect the third-party device 404 from the exercise device 402. In some embodiments, when the third-party device 404 moves away (e.g., moves outside of) from the exercise device 402 farther than the threshold distance 430, the exercise device 402 may prevent operation of the exercise device 402 and/or lock out the exercise device 402.

In some situations, an exercise program may include multiple portions, including a portion that is performed on the exercise device 402 and a portion that is performed off the exercise device 402. For example, a user 434 may perform a weight exercise with a free weight 436. In some situations, the user may move the third-party device 404 away from the exercise device 402 to perform the exercise off of the exercise device 402. The threshold distance 430 may be spaced to allow sufficient room for the user to perform the portion of the exercise program that is off of the exercise device 402.

In some embodiments, the threshold distance 430 may be in a range from the outer perimeter 432 and/or the center of the exercise device 402 having an upper value, a lower value, or upper and lower values including any of less than or equal to 0.1 meters (m), 0.5 m, 1.0 m, 1.5 m, 2.0 m, 2.5 m, 3.0 m, 3.5 m, 4.0 m, 4.5 m, 5.0 m, 5.5 m, 6.0 m, 7.0 m, 8.0 m, 9.0 m, 10.0 m, or any value therebetween. For example, the threshold distance 430 may be greater than 0.1 m. In another example, the threshold distance 430 may be less than 10.0 m. In yet other examples, the threshold distance 430 may be any value in a range between 0.1 m and 10.0 m. In some embodiments, the threshold distance 430 may be less than 2.0 m to prevent inadvertent disconnection of the third-party device 404 from the exercise device 402 during a portion of an exercise program that is located off of the exercise device 402.

The exercise device 402 may determine the location of the third-party device 404 relative to the exercise device 402 in any manner. For example, the exercise device 402 may determine the location of the third-party device 404 based on the travel and return time of a signal transmitted to the third-party device 404 (e.g., an electromagnetic signal, an infrared signal), based on an absolute position within a room, GPS positioning, threshold sensors, any other positioning mechanism, or combinations thereof. In some examples, the threshold distance may be a wireless connection distance between the third-party device and the exercise device.

In some embodiments, the threshold distance 430 may be based on the room in which the exercise device 402 is located. If the third-party device 404 leaves the room, then the exercise device 402 may disconnect the third-party device 404 from the exercise device 402 and/or lockout the exercise device 402.

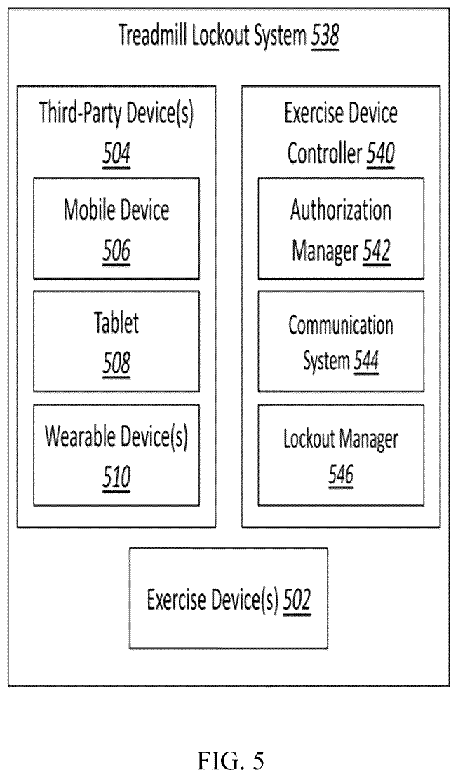

FIG. 5 is a representation of a treadmill lockout system 538, according to at least one embodiment of the present disclosure. Each of the components of the treadmill lockout system 538 can include software, hardware, or both. For example, the components can include one or more instructions stored on a computer-readable storage medium and executable by one or more processors of one or more computing devices, such as a client device or server device. When executed by the one or more processors, the computer-executable instructions of the treadmill lockout system 538 can cause the computing device(s) to perform the methods described herein. Additionally, or alternatively, the components can include hardware, such as a special-purpose processing device to perform a certain function or group of functions. Additionally, or alternatively, the components of the treadmill lockout system 538 can include a combination of computer-executable instructions and hardware.

Furthermore, the components of the treadmill lockout system 538 may, for example, be implemented as one or more operating systems, as one or more stand-alone applications, as one or more modules of an application, as one or more plug-ins, as one or more library functions or functions that may be called by other applications, and/or as a cloud-computing model. Thus, the components may be implemented as a stand-alone application, such as a desktop or mobile application. Furthermore, the components may be implemented as one or more web-based applications hosted on a remote server. The components may also be implemented in a suite of mobile device applications or “apps.”

The treadmill lockout system 538 may include one or more exercise devices 502. An exercise device controller 540 may at least partially control operation of the exercise device 502. As discussed herein, the exercise device controller 540 may manage a connection between and authorization of the connection between the exercise device 502 and one or more third-party devices 504. As discussed herein, the third-party devices 504 may be any type of third-party device, such as a mobile device 506, a tablet 508, a wearable device 510, any other third-party device 504, or combinations thereof.

In some embodiments, the exercise device controller 540 may be located on the exercise device 502. For example, the instructions that implement the functionality of the exercise device controller 540 may be stored on memory of the exercise device 502 and implemented by a processor on the exercise device 502. In some embodiments, the exercise device controller 540 may be located on one or more of the third-party devices 504. For example, the instructions that implement the functionality of the exercise device controller 540 may be stored on memory of the third-party devices 504 and implemented by a processor on the third-party devices. In some embodiments, the exercise device controller 540 may be located at any other location, such as a local server, a remote server, a different device, any other location, and combinations thereof.

The exercise device controller 540 may include an authorization manger 542. Using a communication system 544, the authorization manger 542 may determine whether to connect the third-party devices 504 with the exercise device 502. For example, the exercise device controller 540 may receive a connection request to connect the exercise device 502 to the third-party devices 504. The connection request may be transmitted by the third-party devices 504 and/or the exercise device 502. In some embodiments, the connection request may be made by the exercise device controller 540 when the third-party devices 504 and the exercise device 502 are near each other.

When the exercise device controller 540 receives the connection request, the authorization manger 542 may determine whether the third-party device 504 is authorized to connect to and/or operate the exercise device 502, as discussed in further detail herein. When the authorization manger 542 determines that the third-party device 504 is authorized, then the exercise device controller 540 may connect the third-party device 504 to the exercise device 502. When the authorization manger 542 determines that the third-party device 504 is not authorized, then a lockout manager 546 may prevent operation of the exercise device 502.

As discussed herein, the lockout manager 546 may prevent operation of the exercise device 502 in any manner. For example, the lockout manager 546 may implement a physical lock with a movable element of the exercise device 502, implement programming to prevent adjustment of operating parameters, disconnect power to one or more elements of the exercise device 502, otherwise prevent operation of the exercise device 502, or combinations thereof.

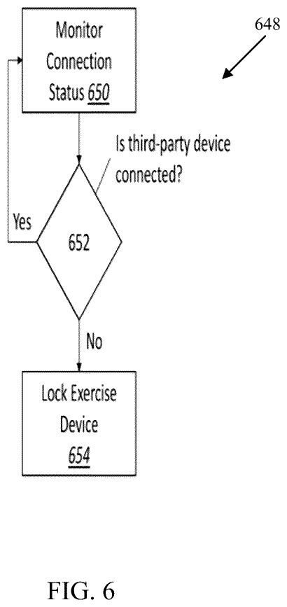

FIGS. 6-9, the corresponding text, and the examples provide a number of different methods, systems, devices, and computer-readable media of the treadmill lockout system 538. In addition to the foregoing, one or more embodiments can also be described in terms of flowcharts comprising acts for accomplishing a particular result, as shown in FIGS. 6-9. FIGS. 6-9 may be performed with more or fewer acts. Further, the acts may be performed in differing orders. Additionally, the acts described herein may be repeated or performed in parallel with one another or parallel with different instances of the same or similar acts.

As mentioned, FIG. 6 illustrates a flowchart of a series of acts or a method 648 for operating an exercise device, according to at least one embodiment of the present disclosure. While FIG. 6 illustrates acts according to one embodiment, alternative embodiments may omit, add to, reorder, and/or modify any of the acts shown in FIG. 6. The acts of FIG. 6 can be performed as part of a method. Additionally, or alternatively, a computer-readable medium can comprise instructions that, when executed by one or more processors, cause a computing device to perform the acts of FIG. 6. In some embodiments, a system can perform the acts of FIG. 6.

In accordance with at least one embodiment of the present disclosure, an exercise device controller may monitor a connection status between an exercise device and a third-party device at 650. Monitoring the connection status may include any type of monitoring. For example, monitoring the connection status may include periodically or episodically checking the connection between the exercise device and the third-party device to determine whether they are connected. For example, periodically monitoring the connection status may include monitoring the connection status every 1 microsecond (μs), 10 μs, 100 μs, 1 millisecond (ms), 10 ms, 100 ms, 1 second(s), 10 s, 30 s, 1 minute (min), 5 min, 10 min, 15 min, 30 min, 45 min, 1 hour, or any time therebetween. In some examples, episodically monitoring the connection status may include monitoring the connection status based on certain events, such as the start of an exercise program, the end of an exercise program, changing an operating parameter of the exercise device, any other event, or combinations thereof.

The exercise device controller may determine 652 whether the third-party device is connected to the exercise device. If the third-party device is connected, then the exercise device controller may continue to monitor the connection status. If the third-party device is not connected, then the exercise device controller may lock the exercise device at 654, or prevent operation of the exercise device.

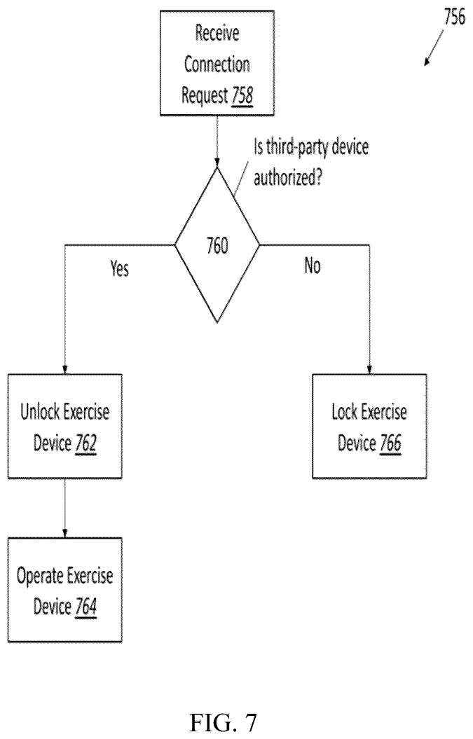

As mentioned, FIG. 7 illustrates a flowchart of a series of acts or a method 756 for operating an exercise device, according to at least one embodiment of the present disclosure. While FIG. 7 illustrates acts according to one embodiment, alternative embodiments may omit, add to, reorder, and/or modify any of the acts shown in FIG. 7. The acts of FIG. 7 can be performed as part of a method. Additionally, or alternatively, a computer-readable medium can comprise instructions that, when executed by one or more processors, cause a computing device to perform the acts of FIG. 7. In some embodiments, a system can perform the acts of FIG. 7.

An exercise device controller may receive a connection request to connect an exercise device and a third-party device at 758. The exercise device controller may determine 760 whether the third-party device is authorized to control or operate the exercise device. If the third-party device is authorized, then the exercise device controller may unlock the exercise device at 762, as discussed herein. The user may then operate the exercise device at 764. If the third-party device is not authorized, then the exercise device controller may lock the exercise device at 766, as discussed herein.

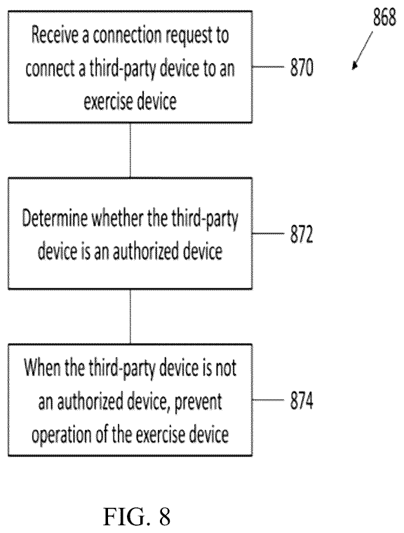

As mentioned, FIG. 8 illustrates a flowchart of a series of acts or a method 868 for operating an exercise device, according to at least one embodiment of the present disclosure. While FIG. 8 illustrates acts according to one embodiment, alternative embodiments may omit, add to, reorder, and/or modify any of the acts shown in FIG. 8. The acts of FIG. 8 can be performed as part of a method. Additionally, or alternatively, a computer-readable medium can comprise instructions that, when executed by one or more processors, cause a computing device to perform the acts of FIG. 8. In some embodiments, a system can perform the acts of FIG. 8.

An exercise device controller may receive a connection request to connect a third-party device to an exercise device at 870. As discussed herein, the exercise device controller may determine whether the third-party device is an authorized device at 872. When the third-party device is not an authorized device, the exercise device controller may prevent operation of the exercise device at 874.

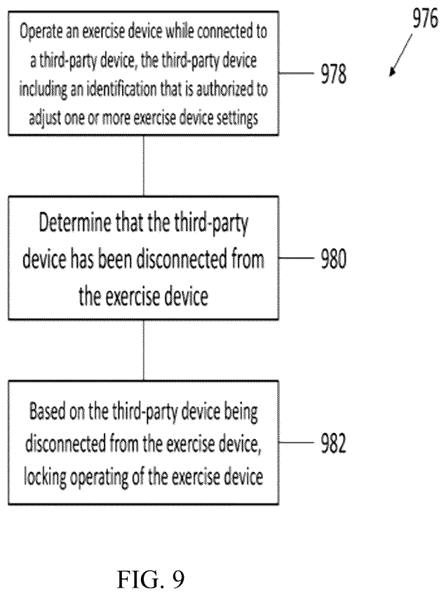

As mentioned, FIG. 9 illustrates a flowchart of a series of acts or a method 976 for operating an exercise device, according to at least one embodiment of the present disclosure. While FIG. 9 illustrates acts according to one embodiment, alternative embodiments may omit, add to, reorder, and/or modify any of the acts shown in FIG. 9. The acts of FIG. 9 can be performed as part of a method. Additionally, or alternatively, a computer-readable medium can comprise instructions that, when executed by one or more processors, cause a computing device to perform the acts of FIG. 9. In some embodiments, a system can perform the acts of FIG. 9.

In accordance with at least one embodiment of the present disclosure, an exercise device controller may operate an exercise device while connected to a third-party device at 978. The third-party device may include an identification or identification information that is authorized to adjust one or more exercise device settings. The exercise device controller may determine that the third-party device has been disconnected from the exercise device at 980. For example, the exercise device controller may monitor the connection status of the third-party device and the exercise device. Based on the third-party device being disconnected from the exercise device, the exercise device controller may lock operation of the exercise device at 982.

This disclosure generally relates to devices, systems, and methods for an exercise device lockout system. The exercise device lockout system may include an exercise device, such as a treadmill, an elliptical device, a rower, a stationary bicycle, a cable extension device, any other exercise device, or combinations thereof. A third-party device may be connected to the exercise device. The exercise device may recognize the third-party device as an authorized third-party device. For example, the exercise device may recognize the third-party device by a device ID (such as an IP address), device type, a user ID that is logged into an application on the third-party device, multi-factor authentication, biometric information, any other authorization mechanism, or combinations thereof. When the exercise device identifies that the third-party device is authorized, the exercise device may be unlocked and/or receive instructions from the third-party device. In some embodiments, when the exercise device identifies that the third-party device is authorized, the exercise device may connect to the user device. The third-party device may send instructions to adjust one or more exercise device settings and/or operating parameters of the exercise device. When the exercise device identifies that the third-party device is not authorized (e.g., is unauthorized), the exercise device may be locked. For example, the exercise device may prevent adjustment of any exercise device settings and/or operating parameters. In some examples, the exercise device may stop operation of the exercise device. In this manner, and in accordance with at least one embodiment, the exercise device may only operate when an authorized device and/or an authorized user is connected to the exercise device.

In accordance with at least one embodiment of the present disclosure, the exercise device may include any type of exercise device. For example, the exercise device may include a treadmill, an elliptical device, a stationary bicycle, a rower, a cable extension device, any other exercise device, or combinations thereof. The exercise device may include one or more movable members. For example, a treadmill may include a motor connected to one or both of a front pulley and a rear pulley. A tread belt may be extended between the front pulley and the rear pulley, and rotation of the front pulley and/or the rear pulley may rotate the tread belt. The treadmill may include a tread deck, and an incline mechanism may change an incline of the tread deck. One or more exercise devices may include a flywheel and a movable device to rotate the flywheel, with the flywheel providing resistance to rotation. For example, an elliptical device may include pedals connected to the flywheel such that, when depressed, the pedals may cause the flywheel to rotate, while the flywheel provides resistance to depression of the pedals. In some examples, a stationary bicycle may include pedals and a drivetrain connected to the flywheel and rotation of the pedals may rotate the flywheel. In some examples, a rower and/or a cable extension device may include a cable connected to the flywheel, and extension of the cable may cause the flywheel to rotate.

The exercise device may include one or more exercise device settings. The exercise device settings may include any setting of the exercise device. For example, the exercise device settings may include a tread belt speed, a flywheel resistance, an incline, a decline, a blower fan setting, any other exercise device setting, and combinations thereof. In some examples, the exercise device may include one or more operating parameters. The operating parameters may include one or more of the exercise device settings.

In accordance with at least one embodiment of the present disclosure, the third-party device may be a device configured to be in communication with the exercise device that is separate from the exercise device. The third-party device may include any type of third-party device. For example, the third-party device may include a user device, or a device owned and/or operated by a user. In some examples, the third-party device may include a mobile device, such as a mobile phone, a smartphone, a tablet, a phablet, a laptop computer, any other mobile device, and combinations. In some examples, the third-party device may include a wearable device, such as a watch, a smartwatch, a ring, a heartrate monitor, a necklace, jewelry, an article of clothing, any other wearable device, and combinations thereof. In some examples, the third-party device may include any other device, including an IoT device, an NFC key, a sensor, a heartrate monitor, any other third-party device, or combinations thereof.

The exercise device may determine whether a third-party device and/or a user is authorized using any authorization mechanism. For example, the third-party device may receive a connection request from the third-party device. The connection request may include any type of connection request, such as a wireless connection request, a wireless connection request over a Wi-Fi network, a wireless connection request over a Bluetooth connection, any other wireless connection, and combinations thereof. The third-party device may determine an identifier for the third-party device based on the connection request. The third-party device may compare the identifier to a pre-approved list of authorized identifiers. If the identifier is on the pre-approved list of authorized identifiers, the exercise device may authorize the third-party device and/or the user. If the identifier is not on the pre-approved list of authorized identifiers, the exercise device may prevent operation of the exercise device. The pre-approved list of identifiers may be pre-determined based on a registration or other verification system. In some examples, authorization mechanism may include a connection to a shared network. For example, the exercise device may authorize the third-party device if the third-party device and the exercise device are connected to the same wireless network, wired network, any other network, or combinations thereof. In some examples, the exercise device may authorize the third-party device if the third-party device was previously authorized.

The identifier may be any type of identifier. For example, the identifier may be associated with the exercise device, such as an IP address that is unique to the third-party device. In some examples, the identifier may be associated with a user. For example, the identifier may be associated with a user login. The user may login to an application used to control the exercise device, and the exercise device may request the login information to receive the identifier. In some examples, the user login may be a user login associated with any application, operating system, server, network, computing device, any other system, and combinations thereof. In some examples, the user login may include a multi-factor authentication system. For example, the exercise device may receive the connection request. If the exercise device recognizes the third-party device, the exercise device may send a multi-factor authentication code to a communication handle associated with the ID in the connection request. If the user inserts the correct multi-factor authentication code, then the exercise device may authorize the third-party device.

In accordance with at least one embodiment of the present disclosure, the exercise device may prevent operation of the exercise device if the third-party device is not authorized. The exercise device may prevent operation of the exercise device in any manner. For example, the exercise device may lock out the exercise device if the third-party device is not authorized. Locking out and/or locking operation of the exercise device may include placing a physical lock or impediment to movement of a movable member of the exercise device. In some examples, locking out the exercise device may include disconnecting a power connection to an operating system of the exercise device. In some examples, locking out the exercise device may include disconnecting one or more input mechanisms from the exercise device. In some embodiments, preventing operation of the exercise device may include not connecting the third-party device to the exercise device. For example, the third-party device may provide instructions to operate the exercise device, and when the third-party device is not connected to the exercise device, the exercise device may not receive any instructions to operate the exercise device.

When the exercise device authorizes the third-party device, the exercise device may connect to the third-party device. For example, the exercise device may establish a two-way communication link between the exercise device and the third-party device. In some embodiments, when the exercise device authorizes the third-party device, the exercise device may be unlocked. For example, the exercise device may physically unlock a physical impediment to a movable member of the exercise device. In some examples, the exercise device may connect power to the exercise device and/or a movable member of the exercise device. In some examples, the exercise device may connect an input mechanism to the exercise device. In some examples, the exercise device may receive instructions from the third-party device to adjust one or more exercise device settings and/or operating parameters of the exercise device. When the exercise device receives the instructions from the third-party device, the exercise device may adjust the associated exercise device setting and/or operating parameter. In this manner, and in accordance with at least one embodiment, the exercise device may adjust its operation when instructed to by an authorized third-party device.

In accordance with at least one embodiment of the present disclosure, the exercise device may monitor the presence and/or connection status of the third-party device. For example, the exercise device may monitor to determine whether the third-party device is still connected to the exercise device. If the third-party device becomes disconnected, then the exercise device may be shut down and/or locked out. For example, if the third-party device becomes disconnected, the exercise device may stop operation of the exercise device and prevent further operation of the exercise device. In some examples, if the third-party device becomes disconnected, the exercise device may stop operation at a safe rate. For example, the third-party device may slow down a tread belt in accordance with industry safety standards (e.g., a safe reduction rate), reduce a resistance on a flywheel in accordance with industry safety standards (e.g., a safe reduction rate), retract cables, or otherwise reduce operation of the exercise device. In some examples, if the third-party device becomes disconnected, the exercise device may be placed in a standby mode. For example, a belt speed of the exercise device may be adjusted to a standby rate, the resistance of the flywheel may be adjusted to a standby resistance, the incline of the exercise device may be adjusted to a standby incline, any other adjustment, or combinations thereof. In some embodiments, if the third-party device is disconnected, the exercise device may wait for a reconnection period. The reconnection period may allow for continued operation of the exercise device during inadvertent disconnections, such as disconnections (e.g., losing a wireless connection) resulting from network connectivity issues, power supply issues, signal interference, any other connectivity issues, or combinations thereof.

As discussed herein, an exercise device may connect to an authorized third-party device. When the exercise device connects to the authorized third-party device, the exercise device may be unlocked. This may facilitate operation of the exercise device by authorized users. In accordance with at least one embodiment, this may facilitate safe operation of the exercise device by preventing access to the exercise device by unauthorized users, such as minors.

As discussed herein, the exercise devices may include any type of exercise device, such as a treadmill, an elliptical device, a stationary bicycle, a rower, a cable extension device, a mirror including a backlit display behind a mirrored surface, any other exercise device, and combinations thereof. While specific exercise devices are discussed herein, it should be understood that the techniques of the present disclosure may be applied to any exercise device that is capable of implementing an exercise program.

The exercise devices may be configured to implement an exercise program. An exercise program may include a series of instructions for a user to perform actions of a workout. The instructions of the exercise program may include a pre-determined set of exercise program controls, which may change the operating parameters of the exercise device at pre-determined times or pre-determined durations after the start of the workout. In some situations, an exercise program may include a video that is synchronized to the instructions and the pre-determined set of exercise program controls. The video may include depictions of a trainer, scenery, third-party media (e.g., movie, television show, streaming video), any other video, and combinations thereof. The video may further include audio, such as commentary by a trainer, music, dialog, sound effects, any other audio, and combinations thereof. In some embodiments, the exercise device may include a console supporting a display. The display may display the video of the exercise program.

In some embodiments, the exercise device may not include a display. For example, the exercise device may be a headless exercise device. Many people own computing devices, such as smartphones, tablets, laptop computers, computer monitors, and so forth. A user may utilize one of his or her devices (e.g., the third-party device) as the display for the exercise device. For example, the exercise program may be accessible by the third-party device, and the third-party device may present the video and/or audio portions of the exercise program. As discussed herein, the third-party device may include any type of third-party device, such as a smartphone, a tablet, wearable device, any other third-party device, and combinations thereof. Not including a display in the exercise device may simplify the exercise device and/or reduce the cost of the exercise device by facilitating use of the user's third-party device.

In accordance with at least one embodiment of the present disclosure, the third-party device may be connected to the exercise device. For example, the third-party device may be connected to the exercise device over an exercise network. The exercise network may be any type of network. For example, the exercise network may be a LAN, a WAN, a Wi-Fi network, a wired network, a cellular network, any other network, and combinations thereof. In some embodiments, the exercise device may be connected to the third-party device over a wireless connection, such as a Bluetooth, Zigbee, Z-wave, near-field communication (NFC), SON, any other wireless connection, and combinations thereof.

When the third-party device is connected to the exercise device, the third-party device may provide instructions to the exercise device. For example, the third-party device may include an exercise program, and the third-party device may provide the exercise program controls based on exercise program to the exercise device over the exercise network. The exercise device may receive the exercise program controls and adjust the operating parameters of the exercise device based on the exercise program. In some embodiments, the third-party device may transmit manual changes to the operating parameters of the exercise device based on input by the user to the third-party device. For example, the third-party device may include an application or a program. In the application, the user may select exercise programs, make manual changes to the operating parameters of the exercise device, review exercise parameters of the user (e.g., duration, distance, pace, speed, simulated weight, calories burned, heartrate, heartrate zone, incline, elevation gain, averages of the foregoing), view video of the exercise program, receive audio of the exercise program, perform any other activity related to the exercise program and/or operating the exercise device, and combinations thereof.

In accordance with at least one embodiment of the present disclosure, the exercise device may have one or more authorized users. An authorized user may be a user that has permission to operate the exercise device. For example, an authorized user may be a user that is above a minimum age, has entered into a user agreement related to operating exercise device, has an account with the operator of the exercise device, has been trained in the operation of the exercise device, is licensed to operate the exercise device, is within certain physical criteria ranges (e.g., weight, height, arm length, weight length, strength, speed), any other authorized user, and combinations thereof. In some embodiments, the exercise device may not be operated except by an authorized user. For example, the exercise device may be locked out unless an authorized user is operating the exercise device. Limiting use of the exercise device to authorized users may improve the safety of operating the exercise device.

In accordance with at least one embodiment of the present disclosure, the exercise device may determine whether a user is authorized based on a connection to the third-party device. For example, when the third-party device is connected to the exercise device, the exercise device may determine whether the user is authorized based on information received from the third-party device. For example, the third-party device may include identifying information. The identifying information may include a unique identifier for the third-party device, such as an IP address. When the third-party device is connected to the exercise device, the exercise device may determine whether the user is authorized based on the unique identifier. For example, the exercise device may compare the unique identifier to a list of authorized identifiers. If the unique identifier is on the list of authorized identifiers, then the exercise device may determine that the user is authorized. In this manner, a person that has access to the third-party device may be authorized to operate the exercise device.

In some embodiments, the exercise device may determine that a user is authorized in any other manner. For example, the third-party device may include a user ID. The user ID may be an ID based on a login to an operating system, a login to an application, a login to a fitness system, any other user ID, and combinations thereof. When the exercise device connects to the third-party device, the third-party device may provide the user ID to the exercise device. In some embodiments, the exercise device may request the user ID from the third-party device, and the third-party device may provide the requested user ID to the exercise device. When the exercise device determines that the user ID belongs to an authorized user, the exercise device may authorize operation of the exercise device, or the exercise device may not prevent operation of the exercise device.

In some embodiments, the exercise device may determine an authorized user in any other manner. For example, the exercise device may determine an authorized user based on a request for additional information. The additional information may include any type of additional information, such as a PIN, a password, biometric information (e.g., fingerprint, face ID, EKG, any other biometric information, and combinations thereof), answering of security questions, MFA, including MFA in the form of a code transmitted to a communication handle (e.g., phone number, email address, social media handle), any other additional information, and combinations thereof. The exercise device may compare the received additional information, and if the received additional information matches additional information in a database or lookup table, then the exercise device may determine that the user of the third-party device is an authorized user (e.g., that the third-party device is an authorized third-party device). While specific examples of authorization of the third-party device and a user associated with the third-party device have been provided herein, it should be understood that the techniques of the present disclosure may be applied to any authorization procedure or mechanism.

When the exercise device determines that the third-party device is an authorized third-party device and/or that the user of the third-party device is an authorized user, the exercise device may become operable for the authorized user. For example, the exercise device may be unlocked such that the authorized user may implement an exercise program or perform a workout on the exercise device.

When the exercise device determines that the third-party device is not authorized (e.g., is unauthorized), the exercise device may prevent operation of the exercise device. Preventing operation of the exercise device may include any mechanism to prevent operation of the exercise device. For example, preventing operation of the exercise device may include preventing movement of a movable element of the exercise device. In some examples, preventing operation of the exercise device may include disconnecting power or a power connection to one or more powered elements of the exercise device, such as one or more motors, brakes, incline mechanisms, and so forth. In some examples, preventing operation of the exercise device may include locking out the exercise device, such as a mechanical lockout, an electrical lockout, an input lockout, any other lockout, and combinations thereof. In some examples, a mechanical lockout may include a mechanical impediment to movement of a movable element, thereby preventing movement of the movable element. In some examples, an input lockout may include a disconnection of one or more input mechanisms, including buttons or other input mechanisms. In some examples, an input lockout may include programming not to accept input from any source in the operating system of the exercise device. Preventing operation of the exercise device may help to reduce inadvertent or unauthorized operation of the exercise device by unauthorized users, thereby reducing the chance of injury by the unauthorized user.

In some embodiments, the exercise device may identify multiple authorization categories. For example, the exercise device may include a full authorization, in which all operating modes are available and operable by the user. In some embodiments, a reduced authorization may limit operation of the exercise device. For example, the reduced authorization may limit a belt speed of the treadmill, a resistance level of a flywheel, an incline level of the exercise device, any other limitation, and combinations thereof. The exercise device may identify the reduced authorization based on the authorization techniques discussed herein.

In accordance with at least one embodiment of the present disclosure, the exercise device may monitor the connection of the third-party device. When the exercise device identifies that the third-party device is disconnected from the exercise device, the exercise device may prevent operation of the exercise device. For example, as discussed herein, the exercise device may lockout the exercise device, implement programming to stop operation of the exercise device, or otherwise prevent operation of the exercise device. In this manner, the exercise device may reduce or prevent unauthorized operation of the exercise device based on the authorized user completing a workout and an unauthorized user utilizing the exercise device after the authorized user.

In some embodiments, the exercise device may gradually stop operation of the exercise device when the third-party device is disconnected. For example, the exercise device may slow a belt speed of the tread belt, such as in accordance with operational safety standards. In some embodiments, the exercise device may gradually reduce the resistance of a flywheel. In some embodiments, the exercise device may gradually reduce the incline of the exercise device. In this manner, the exercise device may stop gradually stop operation, thereby reducing or preventing injury to a user based on a sudden change in operating status of the exercise device.

In some embodiments, stopping operation of the exercise device based on the third-party device disconnecting from the exercise device may include adjusting the operating state of the exercise device to a minimum operating state. For example, a tread belt speed may be reduced to a slow walking pace (e.g., 1 mph, 2 mph), a flywheel resistance may be reduced, an incline may be readjusted to 0° incline, and so forth. In this manner, and in accordance with at least one embodiment of the present disclosure, the exercise device may be returned to an operating state that may reduce or prevent injury.

In accordance with at least one embodiment of the present disclosure, the exercise device may determine that the third-party device has disconnected from the exercise device in any manner. For example, the exercise device may determine that the third-party device is disconnected based on a loss of connection signal between the exercise device and the third-party device. In some examples, the exercise device may determine that the third-party device is disconnected based on the third-party device physically moving out of an operating area of the exercise device.

In some embodiments, the exercise device may provide a reconnection period. For example, the third-party device may become disconnected from the exercise device based on connection issues, or the user temporarily leaving the room in which the exercise device is located. The reconnection period may be a period of time in which the exercise device may not stop operation while attempting to reestablish the connection between the exercise device and the third-party device. This may help to reduce or prevent inadvertent stopping of the exercise device due to inadvertent disconnection of the third-party device from the exercise device.

In some embodiments, an exercise device may not include a display. The exercise device may include one or more movable elements, such as a tread belt, a front pulley at a front end and a rear pulley at a rear end, with the tread belt wrapped around the front pulley and the rear pulley. A belt motor may rotate one or both of the front pulley or the rear pulley, thereby causing the tread belt to rotate in an endless loop. The tread belt may be supported by a tread deck. Two uprights may extend upwards at or near the front end, and a pair of handles may extend between the two uprights. While the exercise device is shown as including the two uprights extending up from the tread deck, it should be understood that the techniques of the present disclosure may be applied to an exercise device including the tread deck and no console, display, two uprights, handles, or other elements extending upward from the tread deck.

During operation of the exercise device, the third-party device may connect to the exercise device. For example, the exercise device may send or receive a connection request from the third-party device, and the third-party device may connect to the exercise device. As discussed herein, the third-party device may connect in any manner, including with a wireless connection. The exercise device may determine whether the third-party device is an authorized third-party device. If the third-party device is authorized, then the third-party device may be connected to the exercise device.

When the third-party device is connected to the exercise device, the third-party device may transmit operating instructions to the exercise device. The operating instructions may include a change to one or more of the operating parameters of the exercise device. For example, the third-party device may transmit instructions to adjust a belt speed of the tread belt, an incline of the tread deck, a fan speed of one or more fans incorporated into the two uprights, any other operating parameter, and combinations thereof.

As discussed herein, if the exercise device does not authorize the third-party device, then the exercise device may prevent operation of the exercise device. For example, the exercise device may prevent the exercise device from rotating the tread belt and/or one or both of the front pulley or the rear pulley. In some examples, the exercise device may prevent adjusting the incline of the tread deck. In this manner, and in accordance with at least one embodiment, the exercise device may prevent unauthorized and/or inadvertent operation of the exercise device, thereby reducing or preventing damage to the exercise device or injury to the unauthorized or inadvertent user.

An exercise device may include one or more movable elements, such as a tread belt, a front pulley at a front end and a rear pulley at a rear end, with the tread belt wrapped around the front pulley and the rear pulley. A belt motor may rotate one or both of the front pulley or the rear pulley, thereby causing the tread belt to rotate in an endless loop. The tread belt may be supported by a tread deck. Two uprights may extend upwards at or near the front end, and a pair of handles may extend between the two uprights.

In the embodiment shown, a console may include a device support. The device support may support a third-party device. The third-party device may be secured to the console by connecting to the device support, such as through a bracket, a clamp, a case for the third-party device, any other connection mechanism, and combinations thereof. In this manner, a user may secure his or her third-party device to the exercise device, thereby placing the third-party device in a location easily viewed while performing the exercise activity.

In accordance with at least one embodiment of the present disclosure, the exercise device may connect to and/or authorize multiple third-party devices. For example, the exercise device may connect to a first third-party device and a second third-party device. The first third-party device and the second third-party device may display different content, include different controls, identify different elements of an exercise program, and so forth. In this manner, the exercise system may be customizable to the user's preferences. In some embodiments, the first third-party device and the second third-party device may be the same type of device. In some embodiments, the first third-party device and the second third-party device may be different devices. For example, the first third-party device may be a tablet and the second third-party device may be a smartphone. In some examples, one of the third-party devices may be a wearable device. In some examples, the third-party devices may include any combinations of devices.

An exercise device may include one or more movable elements, such as a tread belt, a front pulley at a front end and a rear pulley at a rear end, with the tread belt wrapped around the front pulley and the rear pulley. A belt motor may rotate one or both of the front pulley or the rear pulley, thereby causing the tread belt to rotate in an endless loop. As discussed herein, the exercise device may not include a display.

As discussed herein, the exercise device may authorize the third-party device. In accordance with at least one embodiment of the present disclosure, the exercise device may authorize the third-party device when the third-party device is located within a threshold distance of an outer perimeter of the exercise device, and the exercise device may lock the exercise device when the third-party device is outside of the threshold distance. The outer perimeter may be the outer surface of the exercise device. In some embodiments, the threshold distance may be identified based on a distance from a center of the exercise device. When the third-party device moves away from the exercise device further than the threshold distance, the exercise device may disconnect the third-party device from the exercise device. In some embodiments, when the third-party device moves away (e.g., moves outside of) from the exercise device further than the threshold distance, the exercise device may prevent operation of the exercise device and/or lock out the exercise device.

In some situations, an exercise program may include multiple portions, including a portion that is performed on the exercise device and a portion that is performed off the exercise device. For example, a user may perform a weight exercise with a free weight. In some situations, the user may move the third-party device away from the exercise device to perform the exercise off of the exercise device. The threshold distance may be spaced to allow sufficient room for the user to perform the portion of the exercise program that is off of the exercise device.

In some embodiments, the threshold distance may be in a range from the outer perimeter and/or the center of the exercise device having an upper value, a lower value, or upper and lower values including any of less than or equal to 0.1 m, 0.5 m, 1.0 m, 1.5 m, 2.0 m, 2.5 m, 3.0 m, 3.5 m, 4.0 m, 4.5 m, 5.0 m, 5.5 m, 6.0 m, 7.0 m, 8.0 m, 9.0 m, 10.0 m, or any value therebetween. For example, the threshold distance may be greater than 0.1 m. In another example, the threshold distance may be less than 10.0 m. In yet other examples, the threshold distance may be any value in a range between 0.1 m and 10.0 m. In some embodiments, it may be critical that the threshold distance is less than 2.0 m to prevent inadvertent disconnection of the third-party device from the exercise device during a portion of an exercise program that is located off of the exercise device.

The exercise device may determine the location of the third-party device relative to the exercise device in any manner. For example, the exercise device may determine the location of the third-party device based on the travel and return time of a signal transmitted to the third-party device (e.g., an electromagnetic signal, an infrared signal), based on an absolutely position within a room, GPS positioning, threshold sensors, any other positioning mechanism, and combinations thereof. In some examples, the threshold distance may be a wireless connection distance between the third-party device and the exercise device.

In some embodiments, the threshold distance may be based on the room in which the exercise device is located. If the third-party device leaves the room, then the exercise device may disconnect the third-party device from the exercise device and/or lockout the exercise device.

Each of the components of an exercise device lockout system can include software, hardware, or both. For example, the components can include one or more instructions stored on a computer-readable storage medium and executable by one or more processors of one or more computing devices, such as a client device or server device. When executed by the one or more processors, the computer-executable instructions of the exercise device lockout system can cause the computing device(s) to perform the methods described herein. Additionally, or alternatively, the components can include hardware, such as a special-purpose processing device to perform a certain function or group of functions. Alternatively, the components of the exercise device lockout system can include a combination of computer-executable instructions and hardware.

Furthermore, the components of the exercise device lockout system may, for example, be implemented as one or more operating systems, as one or more stand-alone applications, as one or more modules of an application, as one or more plug-ins, as one or more library functions or functions that may be called by other applications, and/or as a cloud-computing model. Thus, the components may be implemented as a stand-alone application, such as a desktop or mobile application. Furthermore, the components may be implemented as one or more web-based applications hosted on a remote server. The components may also be implemented in a suite of mobile device applications or “apps.”

The exercise device lockout system may include one or more exercise devices. An exercise device controller may at least partially control operation of the exercise device. As discussed herein, the exercise device controller may manage a connection between and authorization of the connection between the exercise device and one or more third-party devices. As discussed herein, the third-party devices may be any type of third-party device, such as a mobile device, a tablet, a wearable device, any other third-party device, and combinations thereof.

In some embodiments, the exercise device controller may be located on the exercise device. For example, the instructions that implement the functionality of the exercise device controller may be stored on memory of the exercise device and implemented by a processor on the exercise device. In some embodiments, the exercise device controller may be located on one or more of the third-party devices. For example, the instructions that implement the functionality of the exercise device controller may be stored on memory of the third-party devices and implemented by a processor on the third-party devices. In some embodiments, the exercise device controller may be located at any other location, such as a local server, a remote server, a different device, any other location, and combinations thereof.

The exercise device controller may include an authorization manger. Using a communication system, the authorization manger may determine whether to connect the third-party devices with the exercise device. For example, the exercise device controller may receive a connection request to connect the exercise device to the third-party devices. The connection request may be transmitted by the third-party devices and/or the exercise device. In some embodiments, the connection request may be made by the exercise device controller when the third-party devices and the exercise device are near each other.

When the exercise device controller receives the connection request, the authorization manger may determine whether the third-party device is authorized to connect to and/or operate the exercise device, as discussed in further detail herein. When the authorization manger determines that the third-party device is authorized, then the exercise device controller may connect the third-party device to the exercise device. When the authorization manger determines that the third-party device is not authorized, then a lockout manager may prevent operation of the exercise device.

As discussed herein, the lockout manager may prevent operation of the exercise device in any manner. For example, the lockout manager may implement a physical lock with a movable element of the exercise device, implement programming to prevent adjustment of operating parameters, disconnect power to one or more elements of the exercise device, otherwise prevent operation of the exercise device, and combinations thereof.

In accordance with at least one embodiment of the present disclosure, an exercise device controller may monitor a connection status between an exercise device and a third-party device. Monitoring the connection status may include any type of monitoring. For example, monitoring the connection status may include periodically or episodically checking the connection between the exercise device and the third-party device to determine whether they are connected. For example, periodically monitoring the connection status may include monitoring the connection status every 1 μs, 10 μs, 100 μs, 1 ms, 10 ms, 100 ms, 1 s, 10 s, 30 s, 1 min, 5 min, 10 min, 15 min, 30 min, 45 min, 1 hour, and any time therebetween. In some examples, episodically monitoring the connection status may include monitoring the connection status based on certain events, such as the start of an exercise program, the end of an exercise program, changing an operating parameter of the exercise device, any other event, and combinations thereof.

The exercise device controller may determine whether the third-party device is connected to the exercise device. If the third-party device is connected, then the exercise device controller may continue to monitor the connection status. If the third-party device is not connected, then the exercise device controller may lock the exercise device, or prevent operation of the exercise device.

An exercise device controller may receive a connection request to connect an exercise device and a third-party device. The exercise device controller may determine whether the third-party device is authorized to control or operate the exercise device. If the third-party device is authorized, then the exercise device controller may unlock the exercise device, as discussed herein. The user may then operate the exercise device. If the third-party device is not authorized, then the exercise device controller may lock the exercise device, as discussed herein.

An exercise device controller may receive a connection request to connect a third-party device to an exercise device. As discussed herein, the exercise device controller may determine whether the third-party device is an authorized device. When the third-party device is not an authorized device, the exercise device controller may prevent operation of the exercise device.

In accordance with at least one embodiment of the present disclosure, an exercise device controller may operate an exercise device while connected to a third-party device. The third-party device may include an identification or identification information that is authorized to adjust one or more exercise device settings. The exercise device controller may determine that the third-party device has been disconnected from the exercise device. For example, the exercise device controller may monitor the connection status of the third-party device and the exercise device. Based on the third-party device being disconnected from the exercise device, the exercise device controller may lock operation of the exercise device.

The following provides an overview of aspects of the present disclosure:

Aspect 1: A method for operating an exercise device, the method comprising receiving a connection request to connect a third-party device to the exercise device; determining whether the third-party device is an authorized third-party device; and, when the third-party device is not an authorized third-party device, preventing operation of the exercise device.

Aspect 2: The method of aspect 1, wherein the exercise device includes a treadmill.

Aspect 3: The method of any of aspects 1 or 2, wherein the exercise device includes an elliptical device.

Aspect 4: The method of any of aspects 1-3, wherein the exercise device includes a stationary bicycle.

Aspect 5: The method of any of aspects 1-4, wherein the exercise device includes a rower.

Aspect 6: The method of any of aspects 1-5, wherein the exercise device includes a cable extension device.

Aspect 7: The method of any of aspects 1-6, wherein the exercise device does not include a display.

Aspect 8: The method of any of aspects 1-7, wherein preventing operation of the exercise device includes physically locking a movable element of the exercise device.

Aspect 9: The method of any of aspects 1-8, wherein preventing operation of the exercise device includes disconnecting a power connection to the exercise device.

Aspect 10: The method of any of aspects 1-9, wherein preventing operation of the exercise device includes disconnecting one or more input mechanisms from the exercise device.

Aspect 11: The method of any of aspects 1-10, wherein preventing operation of the exercise device includes not connecting the third-party device to the exercise device.

Aspect 12: The method of any of aspects 1-11, wherein determining whether the third-party device is an authorized device includes comparing identification information for the third-party device to a pre-approved list.

Aspect 13: The method of any of aspects 1-12, wherein determining whether the third-party device is an authorized device includes comparing login information for the third-party device to a pre-approved list.

Aspect 14: The method of any of aspects 1-13, wherein receiving the connection request includes receiving a wireless connection request.

Aspect 15: The method of aspect 14, wherein the wireless connection request includes a wireless connection request over a Bluetooth connection.

Aspect 16: The method of any of aspects 1-15, further comprising determining that the third-party device is within a threshold distance of the exercise device, and wherein receiving the connection request includes receiving the connection request when the third-party device is within the threshold distance.

Aspect 17: The method of aspect 16, wherein the threshold distance is within a room in which the exercise device is located.

Aspect 18: The method of any of aspects 16 or 17, wherein the threshold distance is less than or equal to 2 m from an outer perimeter of the exercise device.

Aspect 19: The method of any of aspects 16-18, wherein the threshold distance is less than or equal to 1 m from an outer perimeter of the exercise device.

Aspect 20: The method of any of aspects 16-19, wherein the threshold distance is less than or equal to 0.5 m from an outer perimeter of the exercise device.

Aspect 21: The method of any of aspects 16-20, wherein the threshold distance is a wireless connection distance between the third-party device and the exercise device.

Aspect 22: The method of any of aspects 1-21, wherein, when the third-party device is an authorized device, authorizing operation of the exercise device.

Aspect 23: The method of aspect 22, wherein authorizing operation of the exercise device includes receiving an input from the third-party device.

Aspect 24: The method of aspect 23, wherein receiving the input from the third-party device includes receiving an input to adjust an operating parameter of the exercise device.

Aspect 25: The method of any of aspects 22-24, wherein authorizing operation of the exercise device includes physically unlocking one or more movable elements of the exercise device.

Aspect 26: The method of any of aspects 22-25, wherein authorizing operation of the exercise device includes connecting a power connection to the exercise device.

Aspect 27: The method of any of aspects 22-26, wherein authorizing operation of the exercise device includes connecting the third-party device to the exercise device.

Aspect 28: The method of any of aspects 22-27, further comprising adjusting at least one operating parameter of the exercise device.

Aspect 29: The method of aspect 28, wherein adjusting the at least one operating parameter includes adjusting at least one of a speed, resistance level, or incline of the exercise device.

Aspect 30: The method of any of aspects 28 or 29, wherein adjusting the at least one operating parameter includes adjusting the at least one operating parameter using the third-party device.

Aspect 31: The method of any of aspects 28-30, wherein adjusting the at least one operating parameter includes adjusting the at least one operating parameter using an input on the exercise device.

Aspect 32: The method of any of aspects 1-31, wherein preventing operation of the exercise device reduces unauthorized use of the exercise device to reduce a risk of injury to the user.

Aspect 33: A computing system including one or more processors and one or more memories, the one or more memories including instructions that cause the one or more processors to implement the method of any of aspects 1-32.

Aspect 34: A method for operating an exercise device, the method comprising operating an exercise device while connected to a third-party device, the third-party device including an identification that is authorized to adjust one or more exercise device settings of the exercise device; determining that the third-party device has been disconnected from the exercise device; and, based on the third-party device being disconnected from the exercise device, locking operation of the exercise device.

Aspect 35: The method of aspect 34, further comprising the method of any of aspects 1-33.

Aspect 36: The method of any of aspects 34 or 35, wherein operating the exercise device includes moving at least one movable member of the exercise device.

Aspect 37: The method of any of aspects 34-36, wherein the exercise device includes a treadmill.

Aspect 38: The method of any of aspects 34-37, wherein the exercise device includes an elliptical device.

Aspect 39: The method of any of aspects 34-38, wherein the exercise device includes a stationary bicycle.

Aspect 40: The method of any of aspects 34-39, wherein the exercise device includes a rower.

Aspect 41: The method of any of aspects 34-40, wherein the exercise device includes a cable extension device.

Aspect 42: The method of any of aspects 34-41, wherein the exercise device does not include a display.

Aspect 43: The method of any of aspects 34-42, further comprising, based on locking the operation of the exercise device, adjusting the one or more exercise device settings to stop operation of the exercise device.

Aspect 44: The method of aspect 43, wherein adjusting the one or more exercise device settings includes adjusting the one or more exercise device settings with a safe reduction rate.

Aspect 45: The method of any of aspects 34-44, wherein locking operation of the exercise device includes physically locking at least one movable member of the exercise device.

Aspect 46: The method of any of aspects 34-45, wherein locking operation of the exercise device includes disconnecting a power connection to the exercise device.

Aspect 47: The method of any of aspects 34-46, wherein determining that the third-party device has been disconnected includes determining that the third-party device is outside of a threshold distance of an outer perimeter of the exercise device.

Aspect 48: The method of aspect 47, wherein the threshold distance is less than or equal to 2 m from an outer perimeter of the exercise device.

Aspect 49: The method of any of aspects 47 or 48, wherein the threshold distance is less than or equal to 1 m from an outer perimeter of the exercise device.

Aspect 50: The method of any of aspects 47-49, wherein the threshold distance is less than or equal to 0.5 m from an outer perimeter of the exercise device.

Aspect 51: The method of any of aspects 34-50, wherein determining that the third-party device has been disconnected includes losing a wireless connection between the exercise device and the third-party device.

Aspect 52: The method of any of aspects 34-51, wherein determining that the third-party device has been disconnected includes determining that an authorized user has logged out of the third-party device.

Aspect 53: A computing system including one or more processors and one or more memories, the one or more memories including instructions that cause the processor to implement the method of any of aspects 34-52.

Aspect 54: An exercise device including the computing system of aspect 53.

Aspect 55: A system of exercise devices comprising the exercise device of aspect 54 and a second exercise device.

Aspect 56: The system of aspect 55, wherein the second exercise device includes the computing system of aspect 52.

Aspect 57: A computer readable media configured to implement any of the methods of any of aspects 1-52.

Aspect 58: A kit including the exercise device of any of aspects 1-57; and instructions to implement the methods of any of aspects 1-57.

Aspect 59: The kit of aspect 58, further comprising the third-party device of any of aspects 1-57, and wherein the instructions instruct the user on how to connect the third-party device to the exercise device.

Aspect 60: The kit of aspect 58, the kit consisting of the exercise device and the instructions.

Aspect 61: The method of any of aspects 34-54, wherein preventing operation of the exercise device reduces unauthorized use of the exercise device to reduce a risk of injury to the user.

Aspect 62: An apparatus (e.g., a computing device, a computing system, an exercise device, an exercise device controller, a treadmill lockout system, or an exercise system) comprising one or more processors and one or more memories, the one or more memories including instructions executable by the one or more processors to cause the apparatus to perform any of aspects 1-33 and/or 34-61.

Aspect 63: Any device, apparatus, system, kit, component, or subcomponent as illustrated or described, or method of manufacture or use thereof.

Aspect 64: An assembly, system, apparatus, and/or device having any or each permutation of features recited in aspects 1-33 and/or 34-61.

Aspect 65: Any system, apparatus, assembly, component, subcomponent, process, element, or portion thereof, as described or illustrated.

Embodiments of the present disclosure may thus utilize a special purpose or general-purpose computing system including computer hardware, such as, for example, one or more processors and system memory. Embodiments within the scope of the present disclosure also include physical and other computer-readable media for carrying or storing computer-executable instructions and/or data structures, including applications, tables, data, libraries, or other modules used to execute particular functions or direct selection or execution of other modules. Such computer-readable media can be any available media that can be accessed by a general purpose or special purpose computer system. Computer-readable media that store computer-executable instructions (or software instructions) are physical storage media. Computer-readable media that carry computer-executable instructions are transmission media. Thus, by way of example, and not limitation, embodiments of the present disclosure can include at least two distinctly different kinds of computer-readable media, namely physical storage media or transmission media. Combinations of physical storage media and transmission media should also be included within the scope of computer-readable media.

Both physical storage media and transmission media may be used temporarily store or carry, software instructions in the form of computer readable program code that allows performance of embodiments of the present disclosure. Physical storage media may further be used to persistently or permanently store such software instructions. Examples of physical storage media include physical memory (e.g., RAM, ROM, EPROM, EEPROM, etc.), optical disk storage (e.g., CD, DVD, HDDVD, Blu-ray, etc.), storage devices (e.g., magnetic disk storage, tape storage, diskette, etc.), flash or other solid-state storage or memory, or any other non-transmission medium which can be used to store program code in the form of computer-executable instructions or data structures and which can be accessed by a general purpose or special purpose computer, whether such program code is stored as or in software, hardware, firmware, or combinations thereof.

A “network” or “communications network” may generally be defined as one or more data links that enable the transport of electronic data between computer systems and/or modules, engines, and/or other electronic devices. When information is transferred or provided over a communication network or another communications connection (either hardwired, wireless, or a combination of hardwired or wireless) to a computing device, the computing device properly views the connection as a transmission medium. Transmission media can include a communication network and/or data links, carrier waves, wireless signals, and the like, which can be used to carry desired program or template code means or instructions in the form of computer-executable instructions or data structures and which can be accessed by a general purpose or special purpose computer.

Further, upon reaching various computer system components, program code in the form of computer-executable instructions or data structures can be transferred automatically or manually from transmission media to physical storage media (or vice versa). For example, computer-executable instructions or data structures received over a network or data link can be buffered in memory (e.g., RAM) within a network interface module (NIC), and then eventually transferred to computer system RAM and/or to less volatile physical storage media at a computer system. Thus, it should be understood that physical storage media can be included in computer system components that also (or even primarily) utilize transmission media.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. An apparatus, comprising:
one or more processors; and
one or more memories comprising instructions executable by the one or more processors to cause the apparatus to:
receive a connection request to connect a third-party device to an exercise device;
determine whether the third-party device is authorized to operate the exercise device; and
prevent an operation of the exercise device when the third-party device is not authorized to operate the exercise device.

2. The apparatus of claim 1, wherein, to prevent the operation of the exercise device, the instructions are further executable by the one or more processors to cause the apparatus to physically lock a movable element of the exercise device.

3. The apparatus of claim 1, wherein, to prevent the operation of the exercise device, the instructions are further executable by the one or more processors to cause the apparatus to physically lock a movable element of the exercise device.

4. The apparatus of claim 1, wherein, to prevent the operation of the exercise device, the instructions are further executable by the one or more processors to cause the apparatus to disconnect a power connection to the exercise device.

5. The apparatus of claim 1, wherein, to prevent the operation of the exercise device, the instructions are further executable by the one or more processors to cause the apparatus to disconnect one or more input mechanisms from the exercise device.

6. The apparatus of claim 1, wherein, to prevent the operation of the exercise device, the instructions are further executable by the one or more processors to cause the apparatus to not connect the third-party device to the exercise device.

7. The apparatus of claim 1, wherein, to determine whether the third-party device is authorized to operate the exercise device, the instructions are further executable by the one or more processors to cause the apparatus to compare identification information or login information for the third-party device to a pre-approved list.

8. The apparatus of claim 1, wherein, to receive the connection request, the instructions are further executable by the one or more processors to cause the apparatus to receive a wireless connection request.

9. The apparatus of claim 1, wherein the instructions are further executable by the one or more processors to cause the apparatus to:
determine that the third-party device is within a threshold distance of the exercise device, wherein the connection request is received when the third-party device is within the threshold distance.

10. The apparatus of claim 1, wherein the instructions are further executable by the one or more processors to cause the apparatus to:
authorize the operation of the exercise device when the third-party device is authorized to operate the exercise device, and wherein, to authorize the operation of the exercise device, the instructions are further executable by the one or more processors to cause the apparatus to:
receive an input to adjust an operating parameter of the exercise device;
physically unlock one or more movable elements of the exercise device;
connect a power connection to the exercise device; or
connect the third-party device to the exercise device.

11. The apparatus of claim 1, wherein the exercise device includes a treadmill, an elliptical device, a stationary bicycle, a rower, or a cable extension device.

12. An apparatus, comprising:
one or more processors; and
one or more memories comprising instructions executable by the one or more processors to cause the apparatus to:
operate an exercise device while connected to a third-party device, the third-party device including an identification that is authorized to adjust one or more exercise device settings of the exercise device;
determine that the third-party device has been disconnected from the exercise device; and
lock an operation of the exercise device based on the third-party device being disconnected from the exercise device.

13. The apparatus of claim 12, wherein the operation of the exercise device comprises moving at least one movable member of the exercise device.

14. The apparatus of claim 12, wherein the instructions are further executable by the one or more processors to cause the apparatus to:
adjust the one or more exercise device settings to stop the operation of the exercise device based on the operation of the exercise device being locked.

15. The apparatus of claim 14, wherein, to adjust the one or more exercise device settings, the instructions are further executable by the one or more processors to cause the apparatus to adjust the one or more exercise device settings with a safe reduction rate.

16. The apparatus of claim 12, wherein, to lock the operation of the exercise device, the instructions are further executable by the one or more processors to cause the apparatus to:
physically lock at least one movable member of the exercise device; or
disconnect a power connection to the exercise device.

17. The apparatus of claim 12, wherein, to determine that the third-party device has been disconnected, the instructions are further executable by the one or more processors to cause the apparatus to:
determine that the third-party device is outside of a threshold distance of an outer perimeter of the exercise device;
determine that a wireless connection between the exercise device and the third-party device has been lost; or
determine that an authorized user has logged out of the third-party device.

18. A method for operating an exercise device, comprising:
receiving a connection request to connect a third-party device to the exercise device;
determining whether the third-party device is authorized to operate the exercise device; and
preventing operation of the exercise device when the third-party device is not authorized to operate the exercise device.

19. The method of claim 18, further comprising:
authorizing the operation of the exercise device when the third-party device is authorized to operate the exercise device; and
adjusting at least one operating parameter of the exercise device using the third-party device when the third-party device is authorized to operate the exercise device, wherein adjusting the at least one operating parameter of the exercise device comprises adjusting at least one of a speed, a resistance level, or an incline of the exercise device.

20. The method of claim 18, wherein the exercise device does not include a display.
